(19) United States
(12) Patent Application Publication
(10) Pub. No.: US 2008/0074692 A1
(43) Pub. Date: Mar. 27, 2008

(54) Image Forming Apparatus

(75) Inventors: Masashi SUZUKI, Nagoya-shi (JP); Hiroshi KOIE, Nagoya-shi (JP); Hideo UENO, Nagoya-shi (JP); Kazunari TAKI, Nagoya-shi (JP); Takahiro IKENO, Seto-shi (JP); Takahiro HOSOKAWA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/859,011

(22) Filed: Sep. 21, 2007

(30) Foreign Application Priority Data
Sep. 25, 2006 (JP) 2006-259138

(51) Int. Cl. G06F 15/00

(52) U.S. Cl. 358/1.15

(57) ABSTRACT

An image forming apparatus comprises: a printing unit which prints an image on a sheet having a non-contact type tag based upon print data, the non-contact type tag stores tag data and transmits/receives the tag data via a wireless communication; a writing unit which stores the tag data in the non-contact type tag; a data forming unit which forms the print data for 1 sheet based upon a print file which requires a plurality of sheets to be printed; and a control unit which controls the printing unit to print on the sheet based upon the print data for 1 sheet formed by the data forming unit, the control unit which controls the writing unit to store file data corresponding to the print data for 1 sheet to be printed in the non-contact type tag of the sheet as the tag data.

### CROSS REFERENCE TO RELATED APPLICATION

The present application claims priority from Japanese Patent Application No. 2006-259138, which was filed on Sep. 25, 2006, the disclosure of which is herein incorporated by reference in its entirety.

### TECHNICAL FIELD

The present invention relates to an image forming apparatus for printing an image on a sheet that has a non-contact type tag for transmitting/receiving tag data via a wireless communication, and the image forming apparatus stores the tag data in the non-contact type tag of the sheet.

### BACKGROUND

Conventionally, it is known that an image forming apparatuses prints images on sheets that have non-contact type tags for transmitting/receiving tag data via wireless communications, and also stores the tag data in the non-contact type tags. For instance, a patent publication 1 discloses an image forming apparatus that detects whether or not an original set on an automatic original feeding apparatus is such a printed matter that has a non-contact type tag, when the image forming apparatus executes a copy operation of the original. When the original is the printed matter having the non-contact type tag, the image forming apparatus reads out image data from the non-contact type tag without conveying the original, and then, prints on a sheet based upon image data. When a non-contact type tag is provided in a sheet to be printed, the image forming apparatus stores the image data in the non-contact type tag.

Also, a patent publication 2 discloses an image forming apparatus which prints image data of a concert ticket on a sheet, and also stores such information as a name, a sex, and a birth date in correspondence with a content of the image data in a non-contact type tag provided with the sheet.

Further, a patent publication 3 discloses an electronic data recording apparatus which reads a remaining storage capacity of the recording medium by a wireless-communication with the recording medium before being inserted into the electronic data recording apparatus, when the electronic data recording apparatus records image data on a recording medium such as a detachably installing type IC card; the electronic data recording apparatus compares the remaining storage capacity of the recording medium with an amount of data to be recorded, and issues a warning when the remaining storage capacity is short for recording the data on the recording medium.

[Patent Publication 1] JP-A-2005-197835

[Patent Publication 2] JP-A-2005-212303

[Patent Publication 3] JP-A-2005-174530

### SUMMARY

In the conventional image forming apparatuses disclosed in the patent publication 1 and the patent publication 2, a data is printed on a sheet of paper, and then, the data is stored in a non-contact type tag of the sheet. However, when the conventional image forming apparatuses carry out a printing operation over a plurality of sheets, there is a problem, namely, what data should be stored in the non-contact type tag. If whole of data is stored in the non-contact type tags respectively which are provided in each sheet, each non-contact type tag has to have a large storage capacity. Also, the electronic data recording apparatus disclosed in the patent publication 3 has such a problem that the printing operation cannot be carried out by only issuing the warning, when the remaining storage capacity is short.

A purpose of the present invention is to provide an image forming apparatus that can store a data in a non-contact type tag without increasing a storage capacity of the non-contact type tag, even when the image forming apparatus prints a print file that requires a plurality of sheets in a printing operation.

According to an aspect of the invention, there is provided an image forming apparatus comprising: a printing unit which prints an image on a sheet having a non-contact type tag based upon print data, the non-contact type tag stores tag data and transmits/receives the tag data via a wireless communication; a writing unit which stores the tag data in the non-contact type tag; a data forming unit which forms the print data for 1 sheet based upon a print file which requires a plurality of sheets to be printed; and a control unit which controls the printing unit to print on the sheet based upon the print data for 1 sheet formed by the data forming unit, the control unit which controls the writing unit to store file data corresponding to the print data for 1 sheet to be printed in the non-contact type tag of the sheet as the tag data.

### BRIEF DESCRIPTION OF THE DRAWINGS

Illustrative aspects of the invention will be described in detail with reference to the following figures wherein:

FIG. 1 is a perspective view of an outer appearance of a multi-function device in accordance with a first embodiment of the present invention;

FIG. 2 is a perspective view of a multi-function device in which a reading unit is opened in accordance with the first embodiment of the present invention;

FIG. 3 is a side sectional view of a major portion of the multi-function device in accordance with the first embodiment of the present invention when the multi-function device is viewed from a shaft direction of a sheet feeding roller;

FIG. 4 is a block diagram for showing an electric system employed in the multi-function device in accordance with the first embodiment of the present invention;

FIG. 5 is a flow chart for showing an example as to a data forming process operation executed by the personal computer in accordance with the first embodiment of the present invention;

FIG. 6 is a flow chart for showing an example as to a printing/writing control process operation executed by the multi-function device in accordance with the first embodiment of the present invention;

FIG. 7 is a flow chart for showing an example as to a data forming process operation executed by the personal computer in accordance with a second embodiment of the present invention;

FIG. 8 is a flow chart for showing an example as to a printing/writing control process operation executed by the multi-function device in accordance with the second embodiment of the present invention;

FIG. 9 is a flow chart for showing an example as to a front half of a printing/writing control process operation executed by the multi-function device in accordance with a third embodiment of the present invention;

FIG. 10 is a flow chart for showing an example as to a rear half of the printing/writing control process operation executed by the multi-function device in accordance with the third embodiment of the present invention;

FIG. 11 is a flow chart for showing an example as to a printing/writing control process operation executed by the multi-function device in accordance with a fourth embodiment of the present invention;

FIG. 12A and FIG. 12B are explanatory diagrams for explaining a printing operation when a file storage capacity is large; and

FIG. 13 is an explanatory diagram for explaining that a sheet has a plurality of non-contact type tags.

### DETAILED DESCRIPTION OF THE PREFERRED EMBODIMENTS

Referring to drawings, a detailed description is following for explaining how to carry out best modes of the present invention.

### First Embodiment

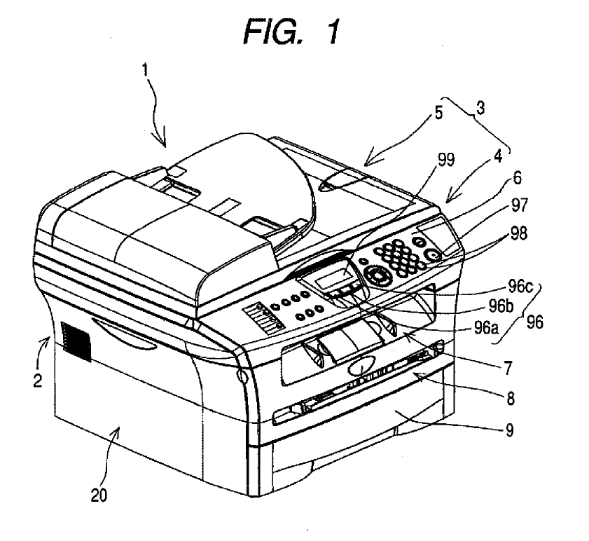

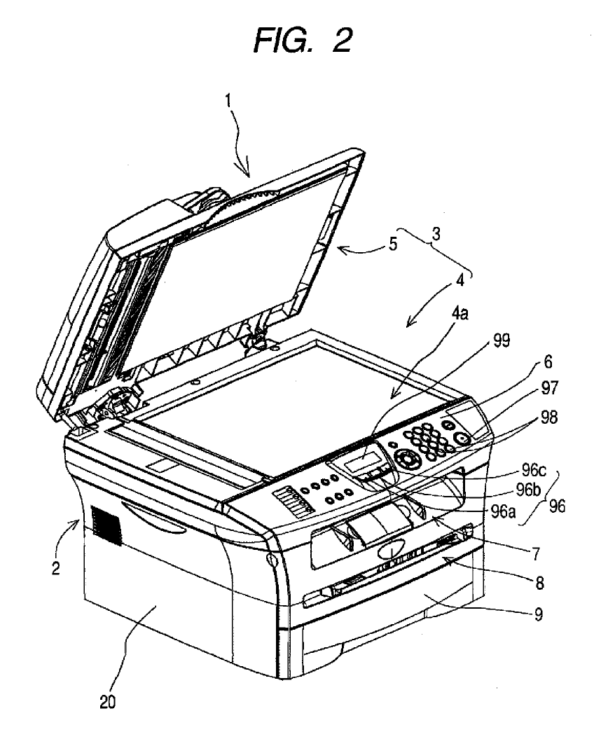

A multi-function device 1 in accordance with a first embodiment is an apparatus for printing an image, which includes a printer function, a scanner function, a copy function. FIG. 1 is a perspective view for showing an outer appearance of the multi-function device 1. Also, FIG. 2 is a perspective view of the multi-function device 1 which shows such a condition that a reading unit 3 is opened. In the below-mentioned description with respect to the multi-function device 1, a side plane (namely, lower right direction as viewed in FIG. 1) where an operation unit 6 has been provided is defined as a “front direction” and an opposite side plane (namely, upper left direction as viewed in FIG. 1) is defined as a “rear direction.”.

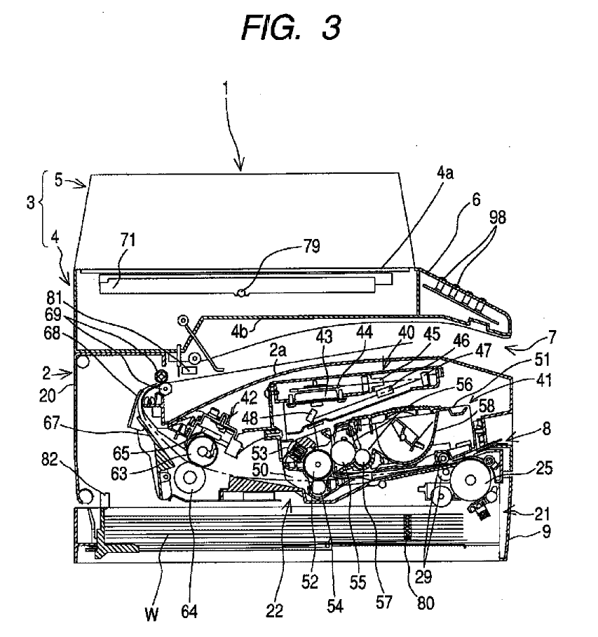

The multi-function device 1 includes an image forming unit 2, and an automatic fed original reading unit 3 (will be referred to as “reading unit 3” hereinafter). The image forming unit 2 includes a feeder unit 21, an image forming section 22 (refer to FIG. 3). As shown in FIG. 1 and FIG. 2, the reading unit 3 includes an image reading device 4, and an automatic original feeding device 5 (will be referred to as “ADF 5” hereinafter). An original base 4a having a rectangular shape is mounted on an upper plane of the image reading device 4. The ADF 5 is arranged in such a manner that the ADF 5 covers the original base 4a. As shown in FIG. 2, a rear edge portion of the reading unit 3, which is located opposite to the operation unit 6, is rotatably supported on the upper rear edge side of the image forming unit 2.

The operation unit 6 in which a user can operate various sorts is provided on one edge side (lower right direction as viewed in FIG. 1) of the image reading device 4. The operation unit 6 includes a mode selection switch 96, a start key 97, various sorts of operation buttons 98, and a touch panel 99 made of a liquid crystal display.

The mode selecting switch 96 can select any one of three sorts of function modes (modes capable of operating FAX function, scanner function, and copy function). Concretely speaking, three mode keys are arrayed in the mode selecting switch 96 along right and left directions. The three mode keys are a copy mode key 96a for selecting a copy mode; a FAX mode key 96b for selecting a FAX (facsimile) mode; and a scanner mode key 96c for selecting a scanner.

The start key 97 is a switch for starting an operation corresponding to a function mode. When the start key 97 is depressed (turned ON) in the copy mode, a multi-function device 1 starts a copying operation for an original mounted on the original base 4a. When the start key 97 is depressed in the FAX mode, a multi-function device 1 carries out a FAX transmission/original reading operation. When the start key 97 is depressed in the scanner mode, a multi-function device 1 carries out a scanner original reading operation.

The touch panel 99 displays a setting menu bottom (not shown)by a predetermined operation. When the setting menu button is touched, the touch panel 99 displays indications related to setting menu of various sorts. Also, a display portion, which is a part of the touch panel 99, displays an error indication, when an error occurs, e.g., a depletion of a sheet W after a print request is issued. The error indication notifies that the error occurs to a user.

A sheet deriving hole 7 is formed at a lower side position of the operation unit 6. The sheet deriving hole 7 is opened and connected to a sheet discharging tray 2a (see FIG. 3, will be explained later). A hand feed-in port 8 is formed in a lower side of the paper deriving hole 7. The hand feed-in port 8 is opened in a slit shape and extended along the horizontal direction. And a sheet feeding cassette 9 is provided on a further lower position of this lower side.

Referring to FIG. 3, a description for explaining the image forming unit 2 is following. FIG. 3 is a side sectional view of a major portion of the multi-function device 1, as viewed from a shaft direction of a feed roller 25. In this drawing, a right side as viewed on this drawing corresponds to the front direction of the multi-function device 1, whereas a left side as viewed on this drawing corresponds to the rear direction of the multi-function device 1.

A feeder unit 21 for feeding a sheet W and an image forming section 22 are located in a casing 20 of the image forming unit 2. The image forming section 22 forms a predetermined image on the fed sheet W. Also, a sheet discharging tray 2a is arranged on an upper portion of the image forming section 22. The sheet discharging tray 2a holds a sheet W on which an image has been formed by the image forming section 22 and then has been discharged.

The feeder unit 21 includes a sheet feeding cassette 9, a sheet depressing plate (not shown) provided in a swingable manner within the sheet feeding cassette 9, a feed roller 25 provided above a front edge-sided edge portion of the sheet feeding cassette 9.

The sheet feeding cassette 9 is arranged on the lower side within the casing 20. The sheet feeding cassette 9 is installed in a detachable manner (can be installed/removed) from a plane on the side of the operation unit 6. A plurality of sheets is stacked and stored in the sheet feeding cassette 9. Thus, a sheet W located at the uppermost position of the sheet feeding cassette 9 is sequentially fed to the side of a register roller 29 via a convey path by the sheet feeding roller 25.

In the first embodiment, a sheet W equipped with a non-contact type tag 80 (Radio Frequency Identification “RFID” tag) is stored in the sheet feeding cassette 9. The non-contact type tag 80 stores information inside itself, and further, transmits and/or receives electromagnetic waves with an antenna (not shown).

The sheet W has the non-contact type tag 80 in a portion of an edge portion of a rectangular-shaped sheet W. As this edge portion of the sheet W, a margin portion near the upper right edge of the sheet W is used which becomes a blank during a printing operation, or alternatively, corner portions (4 corners) of the sheet W may be used. Similar to a normal sheet, the sheet plane of the sheet W can be printed.

A installing/removing sensing unit 82 for sensing installing/removing of the sheet feeding cassette 9 is provided on the side of the rear edge of the sheet feeding cassette 9, when the sheet feeding cassette 9 is installed in the casing 20. The installing/removing unit 82 corresponds to, for example, a photoelectric sensor in which one pair of a light projecting element (not shown) and a light receiving element (not shown) are provided on both sides of the sheet feeding cassette 9. The light receiving element receives light projected from the light projecting element. When the sheet feeding cassette 9 is installed in the casing 20, the light projected from the light projecting element is shielded by the side wall of this sheet feeding cassette 9. When the sheet feeding cassette 9 is removed from the casing 20, the light projected from the light projecting element is received by the light receiving element.

Then, a signal which change in response to amounts of light received by the light receiving element is outputted to a CPU 90, so that the CPU 90 can detect that the sheet feeding cassette 9 is installed in the casing 20, and also, is removed from the casing 20.

The registration roller 29 is a pair of rollers. The driving operation and the stopping operation of this registration roller 29 are controlled by a control circuit 83 based upon sensing timing by a position sensor (not shown) which is arranged near the sheet feeding roller 25. Then, the registration roller 29 corrects oblique travels of the sheet W with this control operation.

The image forming section 22 includes a scanner unit 40, a process unit 41, a fixing unit 42. As shown in FIG. 3, the scanner unit 40 is provided at an upper portion within the casing 20. The scanner unit 40 includes a laser emitting unit (not shown), a polygon mirror 44 which is rotatably driven by a polygon motor 43, lenses 45 and 46, reflection mirrors 47 and 48. A laser beam which is emitted from the laser emitting unit based upon predetermined print data passes through, or is reflected through, the polygon mirror 44, the lens 45, the reflection mirror 47, the lens 46, and the reflection mirror 48 in a sequential manner. Therefore the laser beam is illuminated on a surface of a photosensitive drum 52 provided in a process unit 41 (will be discussed later) in a high speed scanning mode.

The multi-function device 1 includes the process unit 41 which can be installed in/removed from the main body of the image forming unit 2. The process unit 41 includes a drum cartridge 50, and a developing cartridge 51.

In the process unit 41, the drum cartridge 50 includes the photosensitive drum 52, a scotron type charger 53, and a transfer roller 54. Also, the developing cartridge 51 includes a developing roller 55, a layer thickness restricting blade 56 which is contacted onto the developing roller 55 under pressure, a toner supply roller 57, a toner box 58 into which toners (developing agent) are filled.

The photosensitive drum 52 is arranged at a side position of the developing roller 55 in such a manner that the photosensitive drum 52 can be rotated along the clockwise direction under such a condition that this photosensitive drum 52 is located opposite to the developing roller 55. The scorotron type charger 53 is a plus charging-purpose scorotron type charger. The scorotron type charger 53 is arranged to be separated from the photosensitive drum 52 in a predetermined interval in such a manner that this scorotron type charger 53 is not contacted to the photosensitive drum 52.

The surface of the photosensitive drum 52 is uniformly charged in the plus mode by the scotron type charger 53 in connection with the rotation of the photosensitive drum 52. And then, this charged surface is exposed by the laser beam emitted from the scanner unit 40 in the high speed scanning mode, so that an electrostatic latent image is formed on the surface of the photosensitive drum 52 based upon the predetermined print data.

Toners are carried on the developing roller 55 and are charged in the plus mode according with the rotation of the developing roller 55. And then, the toners are supplied to the electrostatic latent image formed on the surface of the photosensitive drum 52, when the toners are contacted with the photosensitive drum 52 in the opposite manner.

The transfer roller 54 is arranged under the photosensitive drum 52 in such a manner that this transfer roller 54 is located opposite to this photosensitive drum 52. And the transfer roller 54 is rotatably supported on the drum cartridge 50 along the counter clockwise direction. Then, the visible image carried on the surface of the photosensitive drum 52 is transferred to a sheet W while this sheet W passes between the photosensitive drum 52 and the transfer roller 54.

The fixing unit 42 is arranged on the down stream side (rear direction side) of the sheet feeding direction, which is lower than the process unit 41. The fixing unit 42 includes a heating roller 63, a pressing roller 64, and a thermistor 65. The heating roller 63 heats toners transferred onto the sheet W so as to melt the toners. The pressing roller 64 is positioned opposite to the heating roller 63, and pressing the sheet W against the heating roller 63.

The heating roller 63 includes a metal element tube functioning as a cylindrical member. A halogen lamp is installed in the heating roller 63 along an axial direction of this metal element tube. The halogen lamp can heat the surface of the heating roller 63 until the temperature thereof becomes a fixing temperature (for example, 200° C.) at which the toners are fixed on the sheet W. The halogen lamp functions as a heater.

The pressing roller 64 includes a metal roller shaft, and a rubber roller. The rubber roller covers a circumference of this roller shaft, and is made of a rubber material. The pressing roller 64 is elastically depressed against the metal element tube of the heating roller 63 by the rubber roller of the pressing roller 64. And then, the pressing roller 64 may be driven in accordance with the rotation of the heating roller 63.

The thermistor 65 is an element whose resistance value is changed in response to a temperature. The thermistor 65 measures a temperature of the heating roller 63 based upon the resistance value thereof. The CPU 90 turns ON/OFF a power supply of the halogen lamp which heats the heating roller 63 in response to the measured temperature. In this way, the CPU 90 controls the temperature of the heating roller 63 so as to become a predetermined temperature.

In such a fixing unit 42, the heating roller 63 heats and presses the toners transferred to the sheet W in the process unit 41 while this sheet W passes between the heating roller 63 and the pressing roller 64, so that the toners are fixed on this sheet W.

Furthermore, the heating roller 63 feeds the sheet W on which the image has been fixed to a sheet discharging roller 69 via a sheet discharging path formed by guide members 67 and 68. Then, the sheet discharging roller 69 discharges the fed sheet W on the sheet discharging tray 2a. An IC writer 81 is provided in the vicinity of the sheet discharging roller 69. The IC writer 81 is located opposite to the non-contact type tag 80 of the sheet W fed by the sheet discharging roller 69. The IC writer 81 can store tag data in the non-contact type tag 80 of the sheet W by generating electromagnetic waves from an antenna (not shown).

The reading unit 3 includes the image reading device 4 and the ADF 5. The image reading device 4 is arranged above the sheet discharging tray 2a of the image forming unit 2 in such a manner that a lower plane 4b of the image reading device 4 is located opposite to the sheet discharging tray 2a and cover the sheet discharging tray 2a.

The reading unit 3 is a flat head type scanner. In the flat head type scanner, the original base 4a is exposed (refer to FIG. 2), when the ADF is opened along the rear direction. Originals are read in a copying operation under such a condition that a book and other originals are mounted on the original base 4a.

It should be understood that reading operations of an original are realized in such a case that the original is mounted on the original base 4a, and also, in another case that the ADF 5 is utilized. When the original is mounted on the original base 4a so as to read the original, a CIS (Contact Image Sensor) 71 is transported along a shaft 79 elongated along the convey direction of the original and further along the original base 4a. In this transporting operation, the reading operation of the original mounted on the original base 4a is carried out every 1 line. On the other hand, when the ADF 5 is utilized so as to read the original, the CIS 71 is transported to the left edge side of the original base 4a, and is maintained at this position, so that the reading operation of the original conveyed by the ADF 5 is carried out every 1 line.

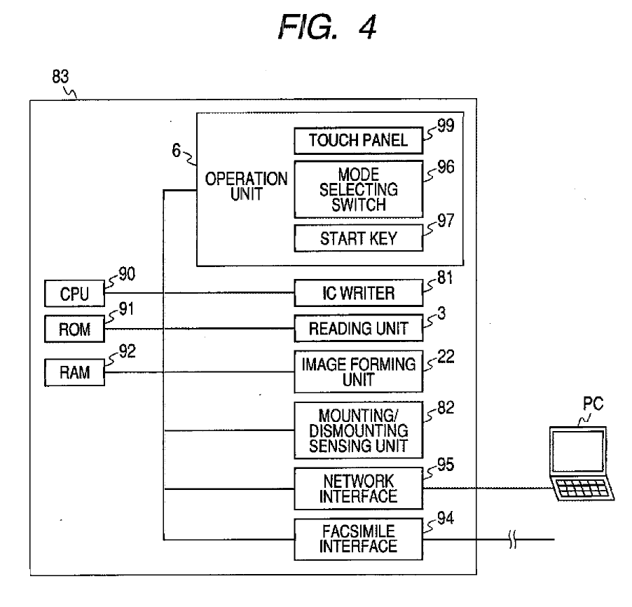

FIG. 4 is a block diagram for showing an electric system of the multi-function device 1 in accordance with the first embodiment of the present invention. As shown in FIG. 4, the multi-function device 1 includes an operation unit 6, a installing/removing sensing unit 82, an IC writer 81, a reading unit 3 for reading an image, an image forming section 22, a ROM 91, a RAM 92, a CPU 90, a facsimile interface 94, and a network interface 95. The operation unit 6 receives various sorts of input operations. The installing/removing sensing unit 82 senses that the sheet feeding cassette 9 is installed and/or removed. The IC writer 81 stores tag data in the non-contact type tag 80. The image forming section 22 performs heating/fixing operations with the printing and fixing unit 42. The facsimile interface 94 is connected to a communication line such as a telephone line. The network interface 95 is connected to a personal computer (will be referred to as “personal computer PC” hereinafter).

When the CPU 90 receives print data transmitted from the external personal computer PC and also receives image data sent from the reading unit 3 since a copy scanning operation is carried out, the CPU 90 stores the print data, the image data, and information added to data (for example, information of user who issues print command, and page information such as total number of print request) in the RAM 92.

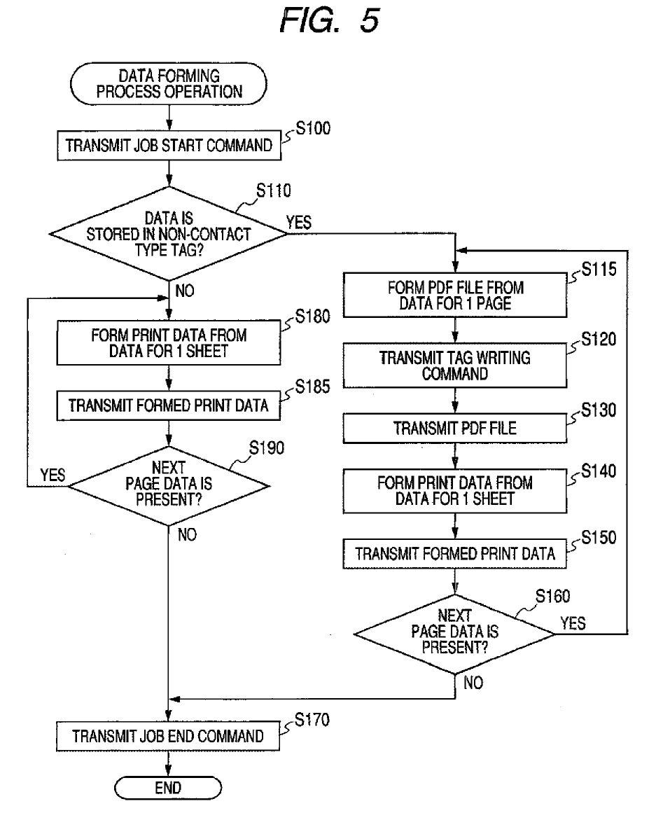

Following description is for explaining a data forming process operation that is executed by the personal computer. FIG. 5 is a flow chart for showing one example of the data forming process operation that is carried out by the personal computer PC in accordance with the first embodiment.

The above-described data processing operation is executed by driver software that has been previously installed in the personal computer PC. In the case that a sentence edited by sentence editing software of the personal computer PC is printed and also a table formed by spreadsheet software is printed, if the above-described multi-function device 1 is selected as a printer for this printing operation and an execution of the printing operation is instructed, then the driver software executes the data forming process operation.

As shown in FIG. 5, firstly, the personal computer PC transmits a job starting command that instructs to start a printing operation to the multi-function device 1 (step 100, will be referred to as “S100” hereinafter). The personal computer PC judges whether or not tag data will be stored in the non-contact type tag 80 after sending the job starting command (S110). The judgment as to whether or not the tag data will be stored is made as follows: For instance, while a check box for inquiring whether or not the tag data is to be stored is displayed on the screen of the personal computer PC, when the check box for indicating whether or not the tag data is stored is checked, the personal computer PC judges that the tag data is to be stored. When the check box for indicating whether or not the tag data is stored is checked, the personal computer PC judges that the tag data is to be stored (YES: S110), and then, forms a PDF file based upon data for 1 page of a print file (S115).

The print file corresponds to a source file of a sentence edited by the sentence editing software installed in the personal computer PC, or a source file of a table formed by executing a spreadsheet program. The print file is such a file with which the multi-function device 1 will print. When the multi-function device 1 prints the content of the print file on sheets, the print file requires a plurality of sheets to be printed. The print file is set in such a manner that printing operations are continuously carried out over a plurality of pages.

In the first embodiment of the present invention, the personal computer PC converts the print file into a file having another format, the personal computer PC transmits the converted file constructed of the print file to the multi-function device 1 as file data. For instance, the personal computer PC converts the print file into such a file having a PDF (Portable Document Format) format, and then, transmits the file having the PDF format to the multi-function device 1. The PDF format has been developed by Adobe System Inc. of USA as the format of the electronic documents, and has been actually distributed as the standard format as to the Internet distribution-purpose document formats. When a print file is converted into a PDF file, a file size thereof may be reduced.

For example, firstly, the personal computer PC converts print data as to a first 1 page of the print file into a file PDF format, so that the PDF file for 1 page to be printed is formed. The personal computer PC may convert either a first 1 page or a last 1 page of the print file into a file PDF format.

The personal computer PC transmits a tag writing command to the multi-function device 1 after forming the PDF file (S120). After transmitting the tag writing command (S120), the personal computer PC transmits the PDF file for 1 page to the multi-function device 1 (S130); the PDF file for 1 page transmitted from the personal computer PC becomes tag data in the non-contact type tag 80, and PDF file is formed based upon the print file by executing the process operation of the step S115.

After transmitting the PDF file (S130), the personal computer PC forms a print data that is equivalent to 1 page (=1 sheet of paper) of the print file converted into the PDF file during the process operation of the step S115, by expanding the print file to the respective pixels (S140).

Next, the personal computer PC transmits the print data for 1 sheet to the multi-function device 1 (step S150). And then, the personal computer PC judges whether or not data of a next page is present based upon a content of the print file (S160). When the print file requires a plurality of sheets in printing operations, the personal computer PC judges that the data of the next page is still present based upon the content of the print file (YES: S160), and then, the personal computer PC repeatedly performs the process operations defined in the step S115 and the subsequent steps thereof so as to form a PDF file based upon data for a next page of the print file (S115).

The personal computer PC transmits a tag writing command to the multi-function device 1 (S120), and then, the personal computer PC transmits the PDF file formed for 1 page to the multi-function device 1 (S130). The personal computer PC forms print data as to the next 1 page (1 sheet of paper) of the print file (S140), and then, the personal computer PC transmits the print data formed for the 1 sheet to the multi-function device 1 (S150).

Similarly, the personal computer PC repeatedly performs the process operations defined in the step S115 and the subsequent steps in order to form a PDF file every 1 page with respect to all of pages contained in the print file which requires the plurality of sheets (S115), and then, the personal computer PC transmits each PDF files to the multi-function device 1 (S130). Subsequently, the personal computer PC forms print data every 1 page (S140), and transmits all of the print data to the multi-function device 1 (S150). It should be understood that the personal computer PC may form and transmit PDF files and print data sequentially from the first page of the print file toward the last page thereof, conversely, or may form and transmit sequentially from the last page of the print data toward the first page thereof.

When the personal computer PC forms the print data every 1 sheet (every 1 sheet of paper) with respect to all of these pages of the print file in the above-described manner and then transmits the print data to the multi-function device 1, the personal computer PC judges that the data of the next page is not present (NO: S160). And then, the personal computer PC transmits a job end command to the multi-function device 1 (S170) so as to accomplish the above-described data forming process operation.

On the other hand, when the personal computer PC judges that the tag data will not be stored in the non-contact type tag 80 by executing the process operation of the step S110 (NO: S110), the personal computer PC forms print data for 1 sheet within the content of the print file in a similar manner to the process operations defined from the step S140 to the step S160 (S180). Next, the personal computer PC transmits the print data for 1 sheet to the multi-function device 1 (S185).

Subsequently, the personal computer PC judges whether or not data of a next page is present based upon a content of the print file (S190). When the personal computer PC judges that the data for the next page is still present based upon the content of the print file (YES: S190), the personal computer PC repeatedly performs the process operations defined in the step S180 and the subsequent steps thereof so as to form print data for 1 sheet which is equivalent to the next page (S180), and then, transmits the print data to the multi-function device 1 (S185). When the personal computer PC forms the print data every 1 sheet with respect to all of these pages of the print file and then transmits the print data to the multi-function device 1, the personal computer PC judges that the data of the next page is not present (NO: S190), and then, transmits a job end command to the multi-function device 1 (S170) so as to accomplish the above-described data forming process operation.

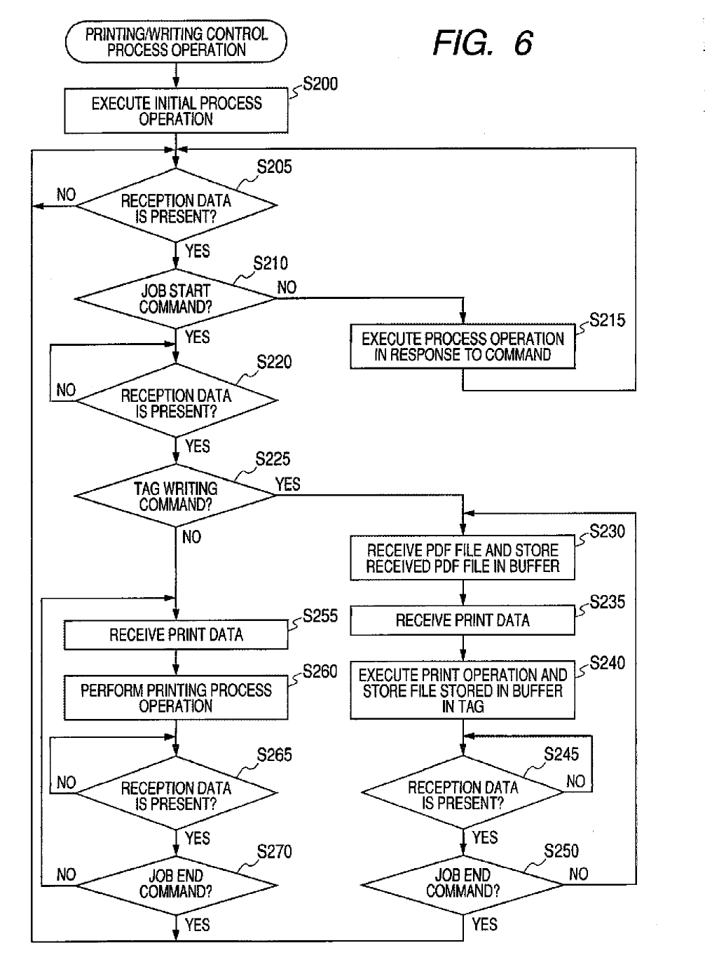

Next, a description is following for explaining a printing/writing control process operation that is executed by the multi-function device 1. FIG. 6 is a flow chart for explaining one example as to the printing/writing control process operation performed by the multi-function device 1 of the first embodiment.

As shown in FIG. 6, the multi-function device carries out the above-described printing/writing control process, when the power supply of the multi-function device 1 is turned ON. The multi-function device 1 executes an initializing process operation for the hardware in order to establish such a condition that a printing operation can be commenced, for instance, operations and original positions (home positions) of various sorts of sensors are confirmed (S200). The multi-function device 1 judges whether or not reception data transmitted from the personal computer PC is present (S205). When certain data is not transmitted from the personal computer PC (NO: S205), the multi-function device 1 is directly brought into a waiting status. Conversely, when the reception data is present (YES: S205), the multi-function device 1 judges whether or not this reception data is the job starting command (S210). When the personal computer PC executes the process operation of the step S100, the job starting command is transmitted from the personal computer PC to the multi-function device 1.

When the reception data is not the job starting command (NO: S210), the multi-function device 1 executes such a process operation responding to this received command (S215), and repeatedly performs the process operations defined in the step S205 and the subsequent steps thereof. When the received data is the job starting command (YES: S210), the multi-function device 1 judges whether or not reception data is present subsequent to the job starting command (S220).

When certain data is not transmitted from the personal computer PC (NO: S220), the multi-function device 1 is directly brought into a waiting status. Conversely, when the reception data is present (YES: S220), the multi-function device 1 judges whether or not this reception data is the tag writing command (S225). This tag writing command is transmitted from the personal computer PC, when the personal computer PC executes the process operation of the step S120.

When the multi-function device 1 receives the tag writing command (YES: S225), the multi-function device 1 judges that tag data that is to be stored in the non-contact type tag 80 is present. And then, subsequent to the tag writing command, the multi-function device 1 receives such a file data which is a PDF file transmitted from the personal computer PC when the personal computer executes the process operation of the step S130 And then, the multi-function device 1 stores this received file data in the buffer of the RAM 92 as the tag data (S230).

Subsequent to the file data, the multi-function device 1 receives print data for 1 page (1 sheet of paper “W”) which is transmitted from the personal computer PC when the personal computer PC executes the process operation of the step S150 (S235). The multi-function device 1 executes a printing process operation which prints on the sheet “W” based upon the received print data, and further, executes such a process operation that the file data which is the PDF file stored in the buffer is stored in the non-contact type tag 80 as tag data (S240).

In the printing process operation, a sheet “W” positioned at the highest position in the sheet feeding cassette 9, in which the non-contact type tag 80 is provided, is sequentially fed via the conveyer path to the registration roller 29 by the feed roller 25. And then, the multi-function device 1 transfers a visible image carried on the surface of the photosensitive drum 52 onto the sheet W. A toner image transferred onto the sheet W is fixed by the heating roller 63 and the pressing roller 64, and the sheet W on which the image has been fixed is conveyed via the sheet discharging path to the discharge roller 69.

In a storing process operation, the IC writer 81 emits electromagnetic waves with an antenna (not shown), when the IC writer 81 is located at such a position that is opposite to the non-contact type tag 80 of the sheet W transported by the discharge roller 69. And then, the IC writer 81 stores the PDF file data stored in the buffer in the non-contact type tag 80 of the sheet W as a tag data. And then, the multi-function device 1 discharges the sheet W to the sheet discharging tray 2a.

The multi-function device 1 judges whether or not reception data is present (S245). When the reception data is not present (NO: S245), the multi-function device 1 is directly brought into a waiting status. When the reception data is present (YES: S245), the multi-function device 1 judges whether or not the reception data is the job end command (S250).

Since the print file requires a plurality of sheets W for the printing operation, the personal computer PC sequentially transmits the PDF file with respect to each of the plural pages W to the multi-function device 1 by executing the process operations defined from the steps S115 to S160, and the personal computer PC sequentially transmits the print data with respect to each of the plural pages to the multi-function device 1. When the print data of the next page is transmitted from the personal computer PC to the multi-function device 1 and the multi-function device 1 judges that the reception data is not the job end command (NO: S250), the multi-function device 1 repeatedly performs the process operations defined in the step S230 and the subsequent steps thereof, and receives both the PDF file and the print data every plural pages (S230 to S235). Also, the multi-function device 1 prints on the sheet W based upon the print data, and stores a PDF file having the same content as that of the print data in the non-contact type tag 80 as the tag data (S240).

When the personal computer PC transmits the job end command to the multi-function device 1 by executing the process operation of the step S170, the multi-function device 1 judges that the job end command is received (YES: S250). And then, since the process operation as to one job is accomplished, the multi-function device 1 waits for a next job starting command while the multi-function device 1 executes the process operations defined in the step S205, the step S210, and the step S215.

On the other hand, when the multi-function device 1 judges that the received data is not the tag writing command by executing the process operation of the step S225 (NO: S225), the multi-function device 1 receives print data for 1 page (1 sheets of paper W) (S255). After that the multi-function device 1 receives the print data, the multi-function device 1 executes a printing process operation for printing on the sheet W based upon the received print data (S260).

After that the multi-function device 1 have carried out the printing process operation (S260), the multi-function device 1 judges whether or not reception data is present (S265). When the reception data is not present (NO: S265), the multi-function device 1 is brought into a waiting status, whereas when the reception data is present (YES: S265), the multi-function device 1 judges whether or not the reception data is the job end command (S270).

The personal computer PC sequentially transmits print data every 1 page to the multi-function device 1 by executing the process operations defined from the steps S180 to S190. When the print data for the next page is transmitted from the personal computer PC to the multi-function device 1 and the multi-function device 1 judges that the reception data is not the job end command (NO: S270), the multi-function device 1 receives the print data for 1 page (S255). After that the multi-function device 1 received the print data, the multi-function device 1 executes a printing process operation for printing on the sheet W based upon the received print data (S260).

The multi-function device 1 repeatedly performs the process operations defined in the step S255 and the subsequent steps thereof so as to print on the sheet W based upon the print data transmitted from the personal computer PC. When the job end command is transmitted from the personal computer PC to the multi-function device 1 by executing the process operation of the step S170, the multi-function device 1 judges that this job end command is received (YES: S270). And then, since the process operation as to one job is accomplished, the multi-function device 1 waits for a next job starting command while the multi-function device 1 executes the process operations defined in the step S205, the step S210, and the step S215.

As previously explained, when the multi-function device 1 stores a print file in the non-contact type tag 80 as file data (YES: S225), the multi-function device 1 prints the content of the print data formed every 1 page on the paper W, based upon print data of the print file for requiring the plurality of sheets W in the printing operation; the multi-function device 1 stores a PDF file containing the same content as that of each 1 page to be printed in the non-contact type tags 80 of the sheet W (S230 to S250).

As a consequence, since a file to be stored in a non-contact type tag 80 corresponds to a PDF file of the page to be stored in the relevant sheet W, the storage capacity of the non-contact type tag 80 may be selected to be small. For example, if all of pages of the print file are converted into a single PDF file and then the single PDF file is stored in a non-contact type tag 80, the non-contact type tag 80 requires for a large storage capacity. Although the personal computer PC converts the print file into the PDF file and the multi-function device 1 store the PDF file in the non-contact type tag, the personal computer PC may divide a print file functioning as a source file into print files every 1 page, and then, the multi-function device 1 may store divided print files in the respective non-contact type tags 80 without converting these divided print files.

### Second Embodiment

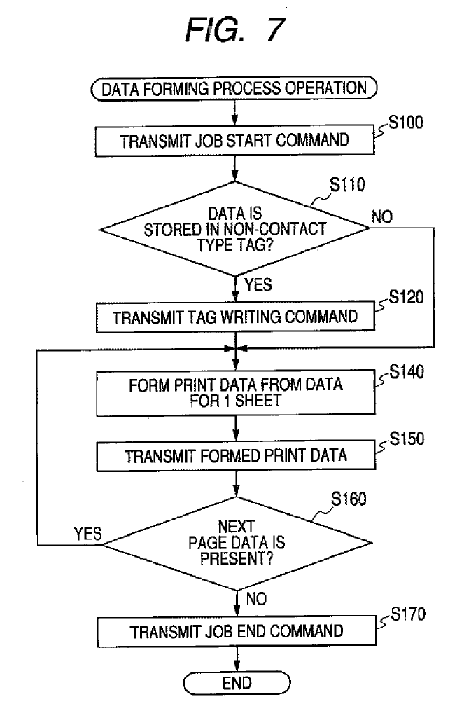

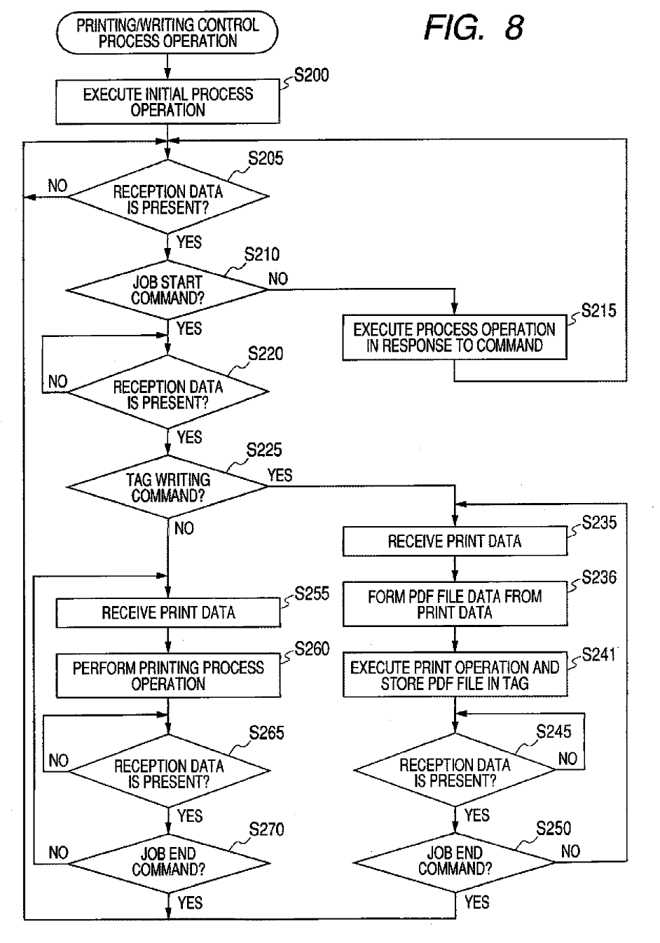

Referring to FIG. 7 and FIG. 8, a description is following for explaining a data forming process operation and a printing/writing control process operation according to a second embodiment of the present invention. FIG. 7 is a flow chart for showing one example of a data forming process operation executed by the personal computer PC of the second embodiment. FIG. 8 is a flow chart for showing one example of a printing/writing control process operation executed by the multi-function device 1 of the second embodiment. It should be understood that the same reference numerals shown in FIG. 5 and FIG. 6 will be employed as those for denoting the same process operations in the data forming process operation and the printing/writing control operation, and descriptions thereof are omitted.

Similar to the above-described embodiment, in the second embodiment, the data forming process operation is carried out by the personal computer PC. As shown in FIG. 7, first of all, the personal computer PC transmits a job starting command for instructing a commencement of a printing operation to the multi-function device 1 (S100). After transmitting the job starting command, the personal computer PC judges whether or not tag data will be stored in a non-contact type tag 80 (S110).

When the multi-function device 1 stores the tag data in the non-contact type tag 80 (YES: S110), the personal computer PC transmits a tag writing command to the multi-function device 1 (S120). Then, the personal computer PC forms print data for 1 page (1 sheet of paper) in the range of a content of a print file (S140). Next, the personal computer PC transmits the print data for 1 page to the multi-function device 1 (S150).

Subsequently, the personal computer PC judges whether or not data as to next page is present based upon the content of the print file (S160). When the personal computer PC judges that the data of the next page is still present based upon the content of the print file (YES: S160), the personal computer PC repeatedly performs the process operations, defined in the step S140 and the subsequent steps thereof so as to form print data for 1 sheet corresponding to the next page (S140), and transmits the print data to the multi-function device 1 (S150). When the personal computer PC forms print data every 1 sheet with respect to all of the pages of the print file and then transmits the print data to the multi-function device 1, the personal computer PC judges that there is no data about the next page (NO: S160), and transmits a job end command to the multi-function device 1 (S170) so as to accomplish the data forming process operation.

When the multi-function device 1 does not store tag data in the non-contact type tag 80 (NO: S110), the personal computer PC forms print data for 1 page without transmitting a tag writing command (S140), and then, transmits the print data for 1 page to the multi-function device 1 (S150).

As shown in FIG. 8, the multi-function device 1 executes the printing/writing control process operation. When the power supply of the multi-function device 1 is turned ON, the multi-function device 1 executes an initializing process operation of hardware (S200), and performs a process operation responding to a command issued from the personal computer PC (S215), and then, repeatedly carries out process operations defined in a step S205 and subsequent steps thereof. When the multi-function device 1 receives the data corresponding to a job starting command (YES: S210), and also, the multi-function device 1 receives a tag writing command (YES: S225), the multi-function device 1 judges that tag data will be stored in the non-contact type tag 80, and thus, receives a print data which is transmitted from the personal computer PC subsequent to the tag writing command by executing the process operation of the step S150 (S235).

Then, the multi-function device 1 forms file data having a PDF format from the received print data (S236). As a result, a PDF file data for 1 page (1 sheet of paper W) in accordance with the print data is formed.

Next, the multi-function device 1 executes a printing process operation for printing on a sheet “W” based upon the received print data, and further, performs such a process operation that a file data is stored in the non-contact type tag 80, while the file data is a PDF file formed from the print data (S241).

Subsequently, the multi-function device 1 judges whether or not reception data is present (S245). When the reception data is not present (NO: S245), the multi-function device 1 is directly brought into a waiting status, whereas when the reception data is present (YES: S245), the multi-function device 1 judges whether or not the reception data is the job end command (S250).

Since a print file requires a plurality of sheets in a printing operation, the personal computer PC sequentially transmits print data for every page to the multi-function device 1 by executing the process operations defined from the step S140 to the step S160. While print data for a next page is transmitted from the personal computer PC to the multi-function device 1, the multi-function device 1 receives the print data for every page (S235), and forms PDF file data with respect to each of the print data (S236). Then, the multi-function device 1 prints on a sheet W based upon the print data, and stores a PDF file having the same content as that of the print data in the non-contact type tag 80 as the tag data (S240).

When the job end command is transmitted from the personal computer PC by executing the process operation of the step S170, and then, the multi-function device 1 judges that this job end command is received (YES: S250), since the process operation as to one job is accomplished, the multi-function device 1 waits for a next job starting command while the multi-function device 1 repeatedly executes the process operations defined in the steps S205, S210, and S215.

On the other hand, when the multi-function device 1 judges that the received data is not the tag writing command by executing the process operation of the step S225 (NO: S225), the multi-function device 1 receives print data for 1 page (S255). After receiving the print data, the multi-function device 1 executes a printing process operation for printing on the sheet W based upon the received print data (S260).

As previously explained, when the multi-function device 1 stores the print file in the non-contact type tag 80 as the file data (YES: S225), in this second embodiment, the multi-function device 1 prints on the sheet W based upon such a print data formed every 1 page of the print file which requires the plurality of sheets W in the printing operation, and forms such a PDF file containing the content of the print data printed every 1 page one based upon the print data, and also stores the PDF file in the relevant non-contact type tag 80 of the sheet W to be printed (S235 to S250).

As a consequence, tag data stored in a non-contact type tag 80 of a sheet is a PDF file which is formed from a print file for every 1 page to be printed, so that the storage capacity of the non-contact type tag 80 may be selected to be small.

### Third Embodiment

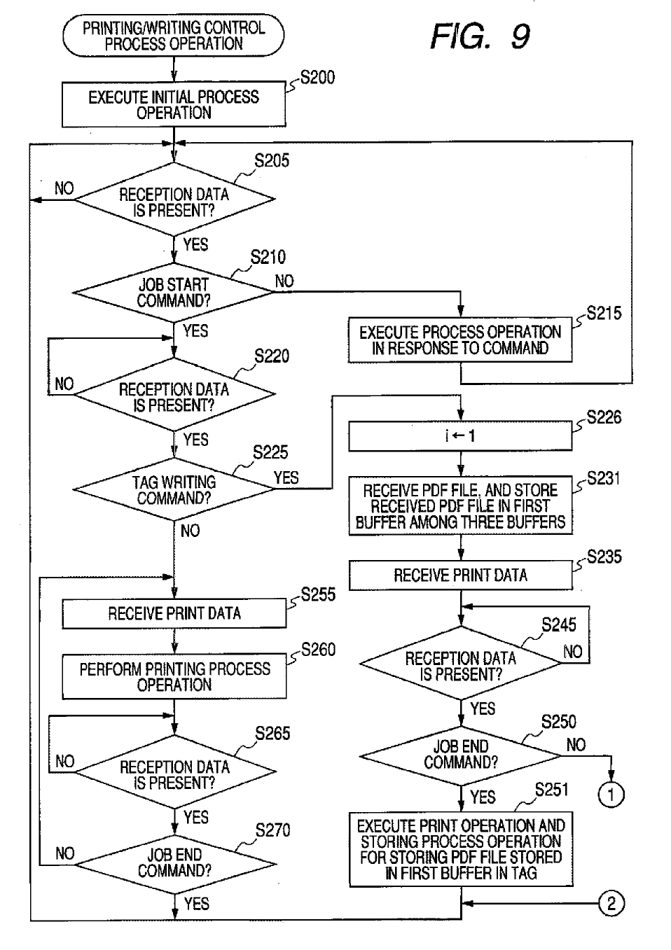

Next, a description is following for explaining printing/writing control process operation according to a third embodiment of the present invention with reference to FIG. 9 and FIG. 10. FIG. 9 and FIG. 10 are flow charts for showing one example of the printing/writing control process operation that is executed by the multi-function device 1 of the third embodiment.

A data forming process operation executed in the personal computer PC is identical to the above-described data forming process operation shown in FIG. 5. The personal computer PC forms a PDF file for 1 page as to all of pages of a print file that requires a plurality of sheets (S115), and then, transmits the PDF files to the multi-function device 1 (S130). At the same time, the personal computer PC forms print data every 1 page (S140), and transmits all of the print data to the multi-function device 1 (S150).

On the other hand, when the power supply of the multi-function 1 is turned ON, the multi-function device 1 executes the printing/writing control process operation indicated in FIG. 9 and FIG. 10. Firstly, the multi-function device 1 executes an initializing process operation of hardware (S200), and performs a process operation responding to a command issued from the personal computer PC (S225), and then, repeatedly carries out process operations defined in the step S205 and subsequent steps thereof. When received data corresponds to a job starting command (YES: S210), and also, the multi-function device 1 receives a tag writing command (YES: S225), the multi-function device 1 judges that there is such a tag data which will be stored in the non-contact type tag 80, and then, substitutes 1 for a buffer counter “i” (S226).

Next, the multi-function device 1 receives such a file data from the personal computer PC subsequent to the tag writing command, the file data is the PDF file transmitted by executing the process operation of the step S130, and then, the multi-function device 1 stores this received file data as the tag data in a first buffer among 3 sets of buffers namely, from the first buffer to a third buffer (S231). The multi-function device 1 receives print data for 1 page (1 sheet of paper W) subsequent to the file data, which is transmitted by executing the process operation of the step S150 by the personal computer PC (S235).

Subsequently, the multi-function device 1 judges whether or not reception data is present (S245). When the reception data is not present (NO: S245), the multi-function device 1 is brought into a waiting status, whereas when the reception data is present (YES: S245), the multi-function device 1 judges whether or not the reception data is the job end command (S250). When the print data is provided only for 1 page, since a job end command is transmitted from the personal computer PC, the multi-function judges that the reception data corresponds to the job end command (YES: S250), and executes a printing process operation for printing on a sheet W based upon the received print data. And further, the multi-function device 1 executes such a process operation that file data, which is the PDF file stored in the first buffer, is stored in the non-contact type tag 80 as tag data (S251). After executing the process operation of the step S251, since the process operation of 1 job is accomplished, the multi-function device 1 waits for a next job starting command while the multi-function device 1 performs the process operations of the steps S205, S210, and S215.

In the case that a plurality of sheets “W” are required to print a print file, the personal computer PC transmits print data for every page and PDF files for every page sequentially to the multi-function device 1 PC by executing the process operations defined from the steps S115 to S160. When print data of a next page is transmitted from the personal computer PC and the multi-function device 1 judges that the reception data is not a job end command (NO: S250), as shown in FIG. 10, the multi-function device 1 adds “1” to the buffer counter “i” (S300).

Next, the multi-function device 1 receives file data that is the PDF file of the next page, and then, stores the file data in the second buffer within the three buffers (from first buffer to third buffer) as the tag data (S305).

Then, the multi-function device 1 executes a printing process operation and a storing process operation (S310). In the printing process operation, the multi-function device 1 prints on the sheet W based upon the print data received from the personal computer PC by executing the process operation of the step S235. In the storing processing operation, the multi-function device 1 stores file data, which is the PDF files stored in the first and second buffers, in the non-contact type tag 80 as to the tag data (S310). As a result, the multi-function device 1 prints the content of the first page on such a sheet “W” which is firstly printed, and the multi-function device 1 stores the PDF file containing the first page and the subsequent page in the non-contact type tag 80 of this sheet W.

Subsequently, the multi-function device 1 receives print data for 1 page (namely, print data of next 1 page) which is transmitted from the personal computer PC by executing the process operation of the step S150 (S315). After receiving the print data, the multi-function device 1 judges whether or not reception data is present (S320). When the reception data is not present (NO: S320), the multi-function device 1 is brought into awaiting status, whereas when the reception data is present (YES: S320), the multi-function device 1 judges whether or not the reception data is the job end command (S325).

When the multi-function device 1 carries out a printing operation for a third page and subsequent pages thereof, since a job end command is not transmitted from the personal computer PC, the multi-function device 1 judges that the reception data is not the job end command (NO: S325), and adds “1” to the buffer counter “i” (S330). Then, the multi-function device 1 receives file data that is a PDF file of the third page, and then, stores this received file data in the buffer as the tag data (S335). Within the three buffers from the first buffer to the third buffer, the multi-function device 1 stores the file data in such a buffer that “1” is subtracted from the buffer counter “i”, and thereafter, is divided by 3 to obtain a remainder (it is so assumed that value of divisor when denominator is selected to 3 is defined as remainder), and then, “1” is added to the remainder. In other words, when the third page is printed, the buffer counter “i” is 3, and such a remainder becomes 2 when 1 is subtracted from 3, 2 is obtained, and 2 is divided by 3 to obtain the remainder. When 1 is added to 2, the resultant value becomes 3, so that the PDF file for the third page is stored in the third buffer.

Next, the multi-function device 1 executes a printing process operation for printing on the sheet W based upon the print data received by executing the process operation of the step S315, and also, executes such a process operation that the multi-function device 1 stores file data, which are the PDF files stored in the first buffer to the third buffer, in the non-contact type tag 80 as the tag data (S340).

As a result, the content of the second page is printed on such a sheet W on which the second page is printed, and the PDF files for 3 pages (namely, from first page to third page) are stored in the non-contact type tag 80 of this sheet W. In other words, the PDF files for these three pages (namely, preceding page, present page, and succeeding page) are stored in the non-contact type tag 80 of the sheet W for the second page.

After storing the PDF file, the multi-function device 1 repeatedly carries out the process operations defined in the step S315 and the subsequent steps thereof. And then, when the multi-function device 1 receives print data for the third page and performs a printing operation for a fourth page by executing the process operation of the step S315, the multi-function device 1 adds “1” to the buffer counter “i” to obtain 4 (S330). And then, such a remainder that 1 is subtracted from 4 to obtain 3 and 3 is divided by 3 becomes 0. When 1 is added to 0, the result value becomes 1. As a result, the multi-function device 1 stores a PDF file of the fourth page in the first buffer (S335). In other words, although the PDF file of the first page has been stored in the first buffer, the PDF file of the fourth page is stored in the first buffer instead of the PDF file of the first page.

Subsequently, the multi-function device 1 executes a printing process operation for printing on the sheet W based upon the print data for the third page received by executing the process operation of the step S315, and also, executes such a process operation for storing the file data, which are the PDF files for the second paper to the fourth page stored in the first buffer to the third buffer, in the non-contact type tag 80 as the tag data (S340).

Again, in the process operation of the step S315, when the print data for the fourth page is received and such a print data for a fifth page is present, the multi-function device 1 adds “1” to the buffer counter “i” to obtain 5 (S330). And then, such a remainder that 1 is subtracted from 5 to obtain 4 and 4 is divided by 3 becomes 1. When 1 is added to 1, then the result value becomes 2. As a result, the multi-function device 1 stores a PDF file of the fifth page in the second buffer (S335). In other words, although the PDF file of the second page has been stored in the second buffer, the PDF file of the fifth page is stored in this second buffer instead of this PDF file of the second page.

Subsequently, the multi-function device 1 executes a printing process operation for printing on the sheet W based upon the print data for the fourth page, and also, executes such a process operation for storing the file data which is made of the PDF files for the third page to the fifth page stored in the first buffer to the third buffer in the non-contact type tag 80 as the tag data (S340).

When the multi-function device 1 receives print data for the fifth page by executing the process operation of the step S315 and the fifth page corresponds to a last page, a job end command is transmitted from the personal computer PC. As a result, the multi-function device 1 judges that the received data is the job end command (YES: S325), and executes a printing process operation for printing the print data of the fifth page on the sheet W based upon the received print data. And further, the multi-function device 1 performs such a process operation that file data is stored in the non-contact type tag 80 as the tag data; the file data are PDF files stored in buffers other than such a buffer having a value obtained by adding 1 to a remainder by dividing the buffer counter “i” by 3 (value of divisor is assumed as remainder when denominator is selected to 3) (S345).

When the fifth page is present, such a remainder obtained by dividing 5 of the buffer counter by 3 becomes 2, and then, 1 is added to 2, so that 3 is obtained. As a result, the multi-function device 1 stores the file data in the non-contact type tag 80 as the tag data, while the file data are the PDF file for the fourth page and the PDF file for the fifth page, which have been stored in such buffers other than the third buffer (namely, PDF file for third page has been stored in this third buffer), namely, stored in the first buffer and the second buffer. As a result, the multi-function device 1 stores two sets of the PDF files for the previous page and the present page in the non-contact type tag 80 provided in the sheet W of the last page. After executing the process operation of the step S345, the process operation for 1 job is accomplished, so that the multi-function device 1 waits for a next job starting command while the multi-function carries out the process operations of the steps S205, S210, and S215.

On the other hand, if the multi-function device 1 judges that the received data is not the tag writing command by executing the process operation of the step S225 (NO: S225), the multi-function device 1 receives print data for 1 page (1 sheet of paper W) (S255). After receiving the print data, the multi-function device 1 executes a printing process operation for printing on the sheet W based upon the received print data (S260).

As previously described, in the third embodiment, when the tag data is stored in the non-contact type tag 80 (YES: S225), the content of the print data is printed on the sheet W based upon the print data formed every 1 page of the print file which requires the plurality of sheets W in the printing operation. Also, the PDF files for 2 pages (namely, both 1 page and subsequent page) are stored in the non-contact type tag 80 in the first page among the PDF files having the same contents printed on the sheet every 1 page. In the next page and the subsequent pages thereof, the PDF files for 3 pages (namely, preceding page, present page, and succeeding page) are stored in the non-contact type tag 80. In the last page, the PDF files for 2 pages (namely, preceding page and own last page) are stored in the non-contact type tag 80.

As a consequence, since the PDF files for the preceding page, the present page, and the succeeding page are stored in the non-contact type tag 80, the storage capacity of the non-contact type tag 80 may be the small storage capacity. For example, if all pages of a print file are converted into a single PDF file and this single PDF file is stored in the non-contact type tag 80, the non-contact type tag 80 requires for a large storage capacity.

Moreover, since the PDF files for the preceding and succeeding pages have been stored, for instance, even when a sheet W of a certain 1 page is lost, the lost sheet W can be reproduced from the PDF files which have been stored in the non-contact type tag 80 of the sheet W for the preceding page and the succeeding page.

In this third embodiment, the multi-function device stores the print file converted into the PDF file in the non-contact type tag. Alternatively, a print file functioning as a source file may be divided every 1 page, and then, the multi-function device 1 stores these divided print files in the respective non-contact type tags 80 without converting these divided print files into PDF file. Also, although the multi-function device 1 stores the preceding page and the succeeding in combination with the own page in the non-contact type tag except for the first page and the last page, the present invention is not limited thereto. Alternatively, the multi-function device 1 may store any one of these preceding and succeeding pages, for example, PDF files for 2 pages (namely, both succeeding page and own page) may be alternatively stored.

### Fourth Embodiment

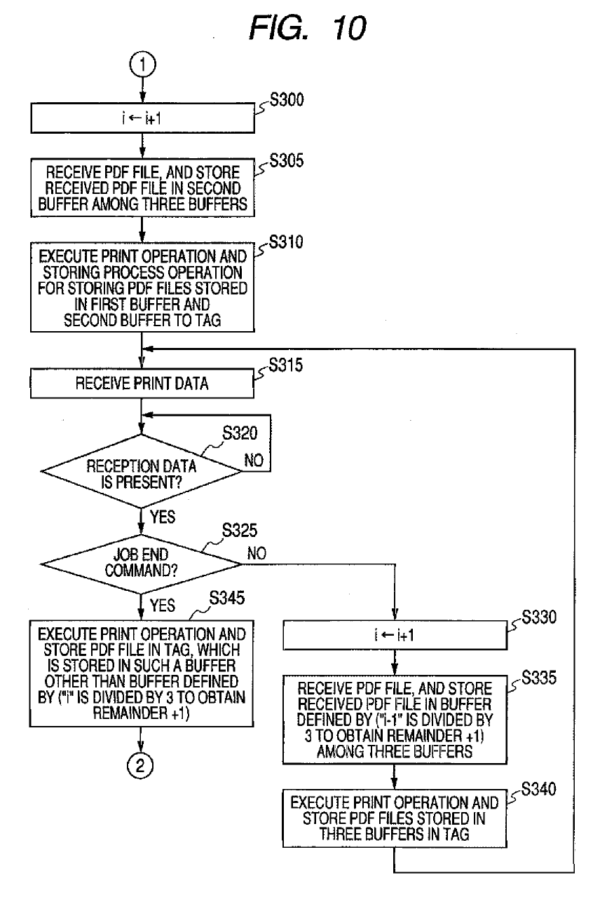

Next, a description is following for explaining printing/writing control process operation according to a fourth embodiment of the present invention with reference to FIG. 11. FIG. 11 is a flow chart for showing one example of the printing/writing control process operation that is executed by the multi-function device 1 of the fourth embodiment.

A data forming process operation executed by the personal computer PC is identical to the above-described data forming process operation shown in FIG. 5. The personal computer PC forms a PDF file for 1 page as to all of pages of a print file that requires a plurality of sheets (S115), and then, transmits the formed PDF files to the multi-function device 1 (S130). At the same time, the personal computer PC forms print data every 1 page (S140), and transmits all of the formed print data to the multi-function device 1 (S150).

On the other hand, when the power supply of the multi-function 1 is turned ON, the multi-function device 1 executes the printing/writing control process operation as shown in FIG. 11. Firstly, the multi-function device 1 executes an initializing process operation of hardware (S200), and performs a process operation responding to a received command issued from the personal computer PC (S215). When received data corresponds to a tag writing command (YES: S225), the multi-function device 1 judges that there is such a tag data which will be stored in the non-contact type tag 80, and then, receives a PDF file to store the received PDF file in a buffer (S230), and also receives print data (S235).

Next, the multi-function device 1 executes a printing process operation for printing on the sheet W based upon the received print data, and also, executes such a process operation for storing that file data, which are PDF files stored in buffers, in the non-contact type tag 80 as the tag data (S241). When the capacity of the each PDF file is large and therefore all of these PDF files cannot be stored in the non-contact type tag 80 with respect to the storage capacity thereof, the multi-function device 1 stores a file portion of the PDF file that can be stored in the non-contact type tag 80.

Then, the multi-function device 1 judges whether or not the entire capacity of the each PDF file have been stored in the non-contact type tag 80 (S242). When the multi-function device 1 cannot store the entire capacity of the each PDF file in the non-contact type tag (NO: S242), the multi-function device 1 executes the process operation of the step S241 so as to form such a PDF file of a difference (remaining) file portion from which the portion stored in the non-contact type tag 80 has been removed from the entire PDF file (S243).

Next, the multi-function device 1 prints such a message “data is present in non-contact type tag” on a sheet W, and also, executes a process operation for storing that file data, which is the PDF file of the difference file portion formed in the process operation of the step S243, in the non-contact type tag 80 as the tag data (S244). Also, when a capacity of the PDF file of the difference file portion still large and the entire capacity of this PDF file cannot be stored in the non-contact type tag 80 in view of the storage capacity, the multi-function device 1 stores a file portion of the PDF file which can be stored in the non-contact type tag 80.

It should also be noted that although no printing operation is carried out on this sheet W based upon the print data in the fourth embodiment, the present invention is not limited thereto. For instance, the multi-function device 1 may alternatively print a content of a print file, which corresponds to the PDF file of the difference file portion, in order that the content of the printed on the sheet may become equal to the content of the PDF file stored in the non-contact type tag 80.

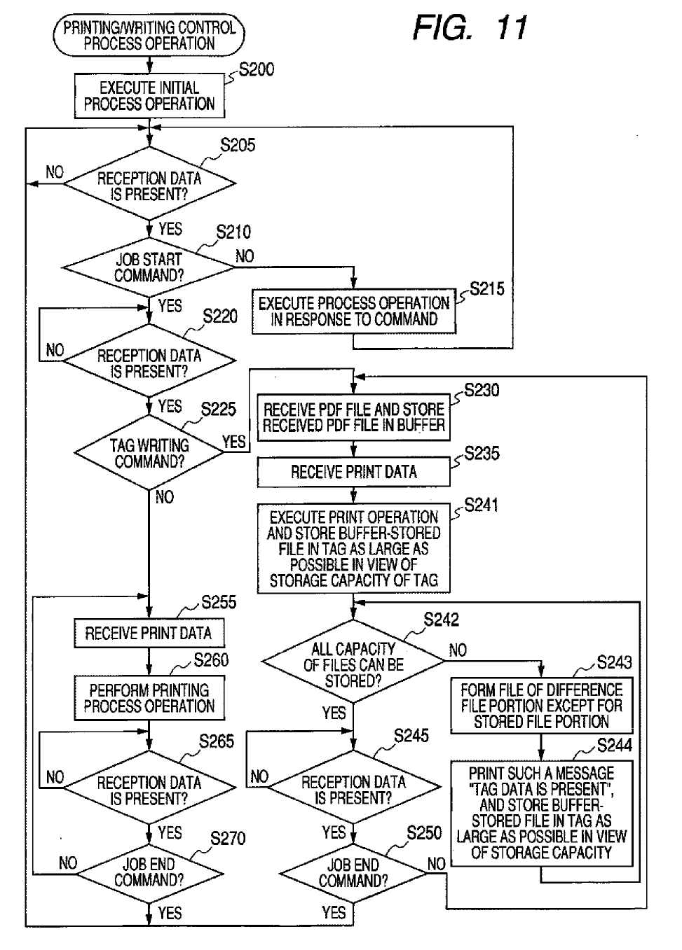

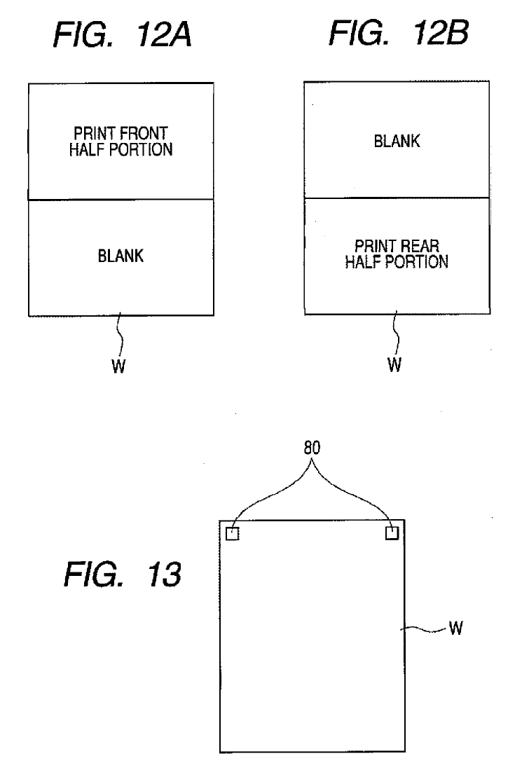

For instance, as shown in FIG. 12A, alternatively, a front half portion of the PDF file may be printed on an upper side of a sheet W and the PDF file having content to be printed may be stored in the non-contact type tag 80; and as represented in FIG. 12B, alternatively, the remaining portion of the PDF file maybe printed on a lower portion of a sheet in the next page, and a PDF file having content to be printed may be stored in the non-contact type tag 80 of the next page.

Subsequently, the multi-function device 1 executes the process operations defined in the step S242 and the subsequent steps thereof. When the multi-function device 1 cannot store the entire capacity of the PDF files (NO: S242), then the multi-function device 1 forms a PDF file of a difference file portion (S243), and prints such a message “data is present in non-contact type tag”, and further, stores this formed PDF file in the non-contact type tag 80 (S244).

When the multi-function device 1 judges that the entire capacity of the PDF file has been stored by executing the process operation of the step S242 (YES: S242), then the multi-function device 1 judges whether or not the reception data is present (S245). When the reception data is not present (NO: S245), the multi-function device 1 is directly brought into a waiting status, whereas when the reception data is present (YES: S245), the multi-function device 1 judges whether or not the reception data is a job end command (S250).

Since a print file requires a plurality of sheets W in a printing operation, the multi-function device 1 repeatedly performs the process operations defined in the step S230 and the subsequent steps thereof so as to receive both a PDF file and print data, and then, prints on the sheet W based upon the received print data. And, the multi-function device 1 stores the received PDF file in the non-contact type tag 80 (S230 to S243). When the multi-function device 1 judges that the job end command is received (YES: S250), since the process operation of one job is accomplished, the multi-function device 1 waits for a next job starting command, while subsequently performing the process operations defined in the steps S205, S210, and S215.

As previously explained, when a size of a PDF file is larger than a storage capacity of a non-contact type tag 80 and the multi-function device 1 cannot store the PDF file in a single non-contact type tag 80, this PDF file is divided into such a file having a storage capacity which can be stored in the single non-contact type tag 80. Since this divided PDF file is stored in the non-contact type tag 80, the storage capacity of this non-contact type tag 80 may be small. Also, since such a message “data is present in non-contact type tag” is printed on the sheet W, it is possible to easily grasp that the tag data has been stored in the non-contact type tag 80.

As shown in FIG. 13, for instance, non-contact type tags 80 having small storage capacities are provided at upper right and left corners of a sheet W. When a large storage capacity is required, tag data maybe stored in these two non-contact type tags 80. Also, when a necessary storage capacity may be covered by only one non-contact type tag 80, a PDF file is stored in the left-sided non-contact type tag 80, whereas a KILL command, or the like is written in the right-sided non-contact type tag 80 so as to be brought into a sleep status thereof. As a result, even when a plurality of non-contact type tags 80 are provided in the single sheet, radio interference may be avoided.

Furthermore, when a sheet W is kept into a file, normally, a left-sided portion of this sheet W is filed, so that the left-sided non-contact type tag 80 becomes a back face side. As a result, a reader (not shown) can easily read tag data. It should also be noted that when a non-contact type tag 80 is provided at an upper left and right corner of a sheet W, no adverse influence may be given to an image quality during a printing operation.

The present invention is not limited only to the above-described embodiments, but may be accomplished in various modes without departing from the gist of the present invention. For instance, although third and fourth embodiments have described that the multi-function device 1 receives the PDF file, the multi-function device 1 may receive a file having another format alternatively. Further, as described in the second embodiment, the multi-function device 1 only receives a print data and may alternatively form such a data to be written in the non-contact type tag 80.

In the above-explained first, third, and fourth embodiments, the image forming apparatus of the present invention includes the personal computer PC and the multi-function device 1, the personal computer PC transmits both the print data every 1 sheet and the file data as the print file to the multi-function device 1; in the second embodiment, the personal computer PC transmits the print data for 1 sheet to the multi-function device 1. In the above embodiment, the personal computer PC connects via the network to the multi-function device 1. Alternatively, the personal computer PC may be connected via either a printer port or a serial port to the multi-function device 1. Also, the personal computer PC and the multi-function device 1 may be alternatively arranged in an integral body. In this alternative case, a memory card and the like in which stores a print file may be inserted into a card reader which is provided in the image forming apparatus so as to read the stored print file. The image forming apparatus need not be necessarily connected to a network. Alternatively, it is required to read only an edited print file. Further, the image forming apparatus does not need a sentence editing function.

The image forming apparatus of the above exemplary embodiments can achieve the below-mentioned advantages. When a print file requires a plurality of sheets in a printing operation, file data corresponding to print data every 1 sheet is stored as tag data in a non-contact type tag of a sheet to be printed. As a result, the file data can be stored in the non-contact type tag having the small storage capacity without increasing the storage capacity of the non-contact type tag. In general, a chip area of a tag having a large storage capacity is larger than that of a tag having a small storage capacity. And, there are large possibilities that the chip having the large storage capacity is broken when a sheet is bent. As a result, it is desirable to employ such a tag having a small storage capacity as small as possible. In accordance with the above exemplary embodiments, use of such tags having large storage capacities can be suppressed to the minimum value, so that there is a small risk of the broken tags, and there is a low cost merit.

Also, file data can be easily formed when the file data is formed from a print file. Otherwise, when the file data is formed from print data, the printing/writing unit can form the file data. Further, when a storage capacity of file data is large, a portion of this file data is stored in a non-contact type tag, then this file data can be stored without increasing the storage capacity of the non-contact type tag. When a content of this file data printed on a sheet is made equal to the content of the file data stored in the non-contact type tag, the content of the non-contact type tag can be easily grasped.

What is claimed is:

1. An image forming apparatus comprising:
a printing unit which prints an image on a sheet having a non-contact type tag based upon print data, the non-contact type tag stores tag data and transmits/receives the tag data via a wireless communication;
a writing unit which stores the tag data in the non-contact type tag;
a data forming unit which forms the print data for 1 sheet based upon a print file which requires a plurality of sheets to be printed; and
a control unit which controls the printing unit to print on the sheet based upon the print data for 1 sheet formed by the data forming unit, the control unit which controls the writing unit to store file data corresponding to the print data for 1 sheet to be printed in the non-contact type tag of the sheet as the tag data.

2. The image forming apparatus according to claim 1, wherein the data forming unit forms the file data that including the print data for printing 1 sheet based upon the print file.

3. The image forming apparatus according to claim 1, wherein the control unit forms the file data based upon the print data for the 1 sheet formed by the data forming unit.

4. The image forming apparatus according to claim 1, wherein the control unit further stores a file data corresponding to at least one sheet of preceding and succeeding sheets to be printed in the non-contact type tag of the sheet as the tag data.

5. The image forming apparatus according to claim 1, wherein when a storage capacity of the file data for the 1 sheet is large and the file data cannot be stored in the non-contact type tag of the sheet, the control unit controls the writing unit to store a portion of the file data in the non-contact type tag of the sheet; and the control unit controls the writing unit to store a remaining portion of the file data in a non-contact type tag of another sheet.

6. The image forming apparatus according to claim 5, wherein the control unit controls the writing unit to store the portion of the file data in the non-contact type tag of the sheet, and controls the printing unit to print on the sheet in correspondence with the portion of the file data; and the control unit controls the writing unit to store the remaining portion of the file data in the non-contact type tag of the another sheet, and controls the printing unit to print on the another sheet in correspondence with the remaining portion of the file data.

7. An image forming apparatus comprising:
a printing unit which prints an image on a sheet having a non-contact type tag based upon print data, the non-contact type tag stores tag data and transmits/receives the tag data via a wireless communication;
a writing unit which stores the tag data in the non-contact type tag;
a data forming unit which forms the print data for 1 sheet based upon a print file which requires a plurality of sheets to be printed; and
a control unit which controls the printing unit to print on the sheet based upon the print data for 1 sheet formed by the data forming unit, the control unit which controls the writing unit to store the print data for 1 sheet to be printed in the non-contact type tag of the sheet as the tag data.

8. An image forming apparatus comprising:
a printing unit which prints an image on a sheet having a non-contact type tag based upon print data, the non-contact type tag stores tag data and transmits/receives the tag data via a wireless communication;
a writing unit which stores the tag data in the non-contact type tag;
a data forming unit which forms the print data for 1 sheet based upon a print file which requires a plurality of sheets to be printed, the data forming unit forms the file data corresponding to the print data for 1 sheet based upon the print file, the data forming unit divides the file data corresponding to the print data for 1 sheet into some file data; and
a control unit which controls the printing unit to print on the sheet based upon the print data for 1 sheet formed by the data forming unit, the control unit which controls the writing unit to store each divided file data respectively in the non-contact type tags of a plurality of sheets to be printed as the tag data.
